(19) United States
(12) Patent Application Publication
(10) Pub. No.: US 2008/0215653 A1
(43) Pub. Date: Sep. 4, 2008

(54) Data Processing Device with Multi-Endian Support

(76) Inventors: Gunther Fenzl, Neubiberg (DE); Carsten Sydow, Ottobrunn (DE)

Correspondence Address: SLATER & MATSIL LLP, 17950 PRESTON ROAD, SUITE 1000, DALLAS, TX, 75252, US

(21) Appl. No.: 11/962,658

(22) Filed: Dec. 21, 2007

(30) Foreign Application Priority Data
Dec. 22, 2006 (DE) 10 2006 061 050.4

(51) Int. Cl. G06F 17/14

(52) U.S. Cl. 708/400

(57) ABSTRACT

A data processing device includes at least one first and one second component which are coupled to one another. The first component is operable in a first endian mode, while the second component is operable in a second endian mode, which is different from the first endian mode.

This application claims priority to German Patent Application 10 2006 061 050.4, which was filed Dec. 22, 2006 and is incorporated herein by reference.

### TECHNICAL FIELD

Embodiments of the present invention relate to a data processing device.

### BACKGROUND

In data processing devices or computers, the memory is usually divided into units referred to as bytes. In this case, one byte typically comprises eight bits, where each of the bits can assume a value of either 0 or 1. Consequently, numerical values of, in decimal representation, 0-255 can be represented by one byte. The representation of larger numerical values necessitates the use of a plurality of bytes that are combined to form a data word. There are a number of options for arranging the individual bytes in the data word. The way in which the bytes are arranged is referred to herein as endian mode. In particular, in this context a so-called little endian mode is known, in which small-value bytes are arranged first. Furthermore, a big endian mode is known, in which large-value bytes are arranged first. Some data processing units and operating systems operate in the little endian mode, while others operate in the big endian mode. Some data processing units and operating systems are able to support both the little endian mode and the big endian mode. In this case, a changeover between the little endian mode and the big endian mode is possible. The endian mode influences both the hardware and the software of a data processing system.

Data processing devices comprising a plurality of data processing units or processors, peripheral units and connecting structures, typically within a single integrated circuit, are referred to herein as embedded systems. The processors can be central data processing units (central processing unit, CPU), digital signal processors (DSP) or hardware accelerators. An operating system such as Linux, WinCE or a proprietary operating system such as Brillianto can be executed on these data processing units. Each data processing unit and the operating system running on the data processing unit are configured for operating either in the big endian mode or the little endian mode.

Peripheral units within an embedded system typically serve as an interface of the data processing units towards the outside (for example, a DDR-SDRAM controller, a USB interface, a PCIe bus or the like), for data transfer between two locations (for example, a DMA controller) or for supporting the data processing units in order to accelerate the data processing (for example, in the case of encryption). Consequently, the peripheral units must also cope with the different endian modes.

Connecting structures within an embedded system can be buses such as, for example, a bus in accordance with the Advanced Microprocessor Bus Architecture (AMBA), in accordance with the “Advanced High Performance (AHB)” specification or in accordance with the “Flexible Peripherals Interface (FPI)” specification. Furthermore, so-called crossbars or switching arrays can also be used as connecting structures. In general, the connecting structures must also cope with the respective endian mode of the data processing units or of the peripheral units.

In existing solutions for systems with mixed endian configuration, however, a common endian mode is always chosen for the processors of an embedded system or more generally for the components of a data processing device

### SUMMARY OF THE INVENTION

In accordance with one embodiment of the invention, a data processing device is provided. The device includes at least a first component and a second component that are coupled to one another. The first component is operable in a first endian mode, while the second component is operable in a second endian mode, which is different from the first endian mode.

### BRIEF DESCRIPTION OF THE DRAWINGS

The invention is explained in more detail below by referring to non-limiting embodiments and to the accompanying drawings, in which:

FIG. 1 schematically shows a data processing device in accordance with one exemplary embodiment of the invention;

FIGS. 2a and 2b schematically show the functioning of a conversion device used in the data processing device in accordance with one exemplary embodiment of the invention; and

FIGS. 3a and 3b schematically show the functioning of a further conversion device used in the data processing device in accordance with one exemplary embodiment of the invention.

### DETAILED DESCRIPTION OF ILLUSTRATIVE EMBODIMENTS

The invention is explained in more detail below on the basis of an exemplary embodiment relating to a data processing device with multi-endian support and configured as an embedded system. The data processing device can be part of a communication system, for example, of a so-called Voice-over-Internet-Protocol communication system, or more generally of a computer system. It is to be understood, however, that the concepts illustrated below can also be applied to other fields of application. Furthermore, it is to be understood that in the figures and the associated description each connection or coupling illustrated can be configured in direct or indirect fashion, that is to say that further functional blocks or units can be coupled between the functional blocks or units illustrated. The illustrated bit widths of the connections are chosen merely by way of example and can, of course, be adapted according to the requirements of the application.

In accordance with the embodiment, in the data processing device according to the invention provision can be made for configuring the hardware architecture in such a way that access to property information of accesses, for example, to a memory, are made accessible to at least some or all components of the system. The access property information can comprise, in particular, an access type (fetching an instruction, loading data, storing data, data width) and an endian mode of the access (for example, big endian mode or little endian mode). It is ensured in this way that the requested instructions or data are communicated correctly, independently of the endian mode.

In accordance with the embodiment, the data processing device may be implemented on a single semiconductor chip, i.e., configured as an embedded system. The data processing device can be used in a communication system, for example, a Voice-over-Internet-Protocol communications system or in a computer system.

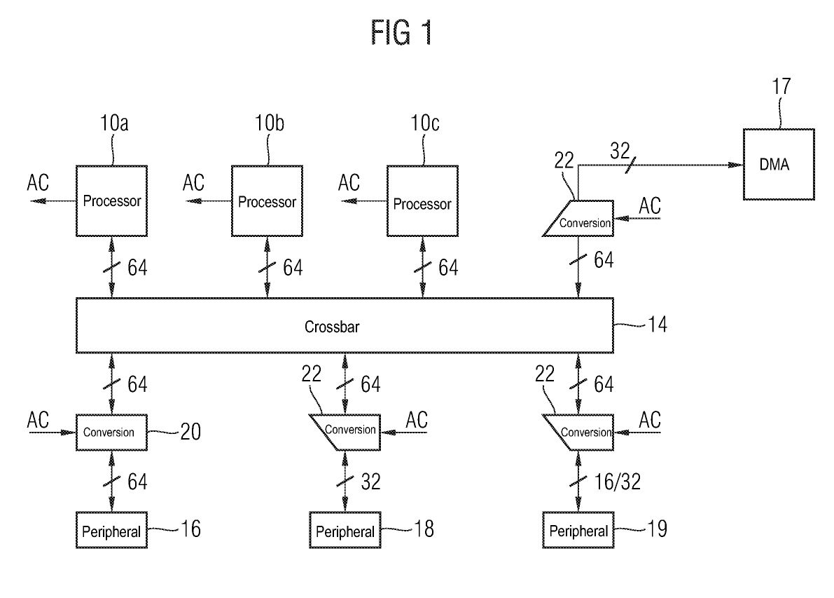

FIG. 1 schematically illustrates a data processing device configured as an embedded system. The data processing device comprises a plurality of processors (or data processing units) 10a, 10b, 10c within a single integrated circuit. The processors 10a, 10b, 10c can be, for example, a CPU 10a, a DSP 10b and a hardware accelerator 10c. The processors 10a, 10b, 10c are each coupled to a crossbar 14 via a data connection having a width of 64 bits. The crossbar 14 serves for interconnecting the processors 10a, 10b, 10c and also for connecting the processors 10a, 10b, 10c to peripheral units 17, 18, 19. The peripheral units can comprise, for example, a DMA controller 17, a system bus 18 and/or a memory controller 19. The system bus 18 can be configured as an FPI bus, as an AMBA bus or as an AHB bus. The memory controller 19 can be configured, for example, for access to memories of the DDR-SDRAM type. Furthermore, the crossbar 14 connects the processors 10a, 10b, 10c to a ROM memory device 16. The ROM memory device 16 serves for storing an operating code or boot code for the processors 10a, 10b, 10c. The processors 17, 18, 19 and the peripheral units are also referred to below as components of the data processing device.

The data processing device furthermore comprises conversion devices 20, 22, which are respectively coupled between the crossbar 14 and the ROM memory device 16 and the peripheral units 17, 18, 19. Depending on a control signal AC, the conversion devices 20 bring about an interchange of bytes within the data words communicated via them. Moreover, the conversion devices 22 also bring about an adaptation of the data width, for example, between 64 bits and 32 bits or between 64 bits and 16 bits.

Depending on an access initiated by one of the processors 10a, 10b, 10c or one of the peripheral units 17, 18, 19, the control signal AC is generated by the respectively initiating component. The control signal AC comprises an access property information comprising an access type (fetching an instruction, loading data, storing data, data width) and the endian mode of the access. In this case, the endian mode of the access is determined by the endian mode of the component which initiates the access. The endian mode can be the little endian mode or the big endian mode. In the context of the data width it is possible to define, in particular, whether only a byte, a complete data word which takes up the full data width of the connection, or a partial data word which comprises a plurality of bytes but only takes up part of the data width of the data connection, is transferred during the access. For example, half data words which take up only half the data width of the data connection can be transferred. This information is used by the conversion devices 20, 22 in order to ensure a correct communication of the data or addresses even in the case of different endian modes of the components 10a, 10b, 10c, 17, 18, 19 of the data processing device.

If the data connection between the components 10a, 10b, 10c, 17, 18, 19 supports a plurality of logical channels, for example, for the connection to the DMA controller 17 which comprises a plurality of logical DMA channels, the conversion is effected individually for each of the logical channels.

The illustrated structure allows for operating each of the components 10a, 10b, 10c, 17, 18, 19 of the data processing device in its own endian mode. This relates to the processors 10a, 10b and 10c, in particular. The latter, independently of their endian mode, can access the ROM memory device 16 in order to load instructions to be executed. In particular, an access to the correct memory addresses is always ensured. There are no particular limitations with regard to the operating code stored in the ROM memory device 16. In particular, the operating code can be adapted for any desired endian mode, the correct execution being ensured by the conversion device 20 between the crossbar 14 and the ROM memory device 16. Both relative jumps between memory addresses and absolute jumps between memory addresses can be used in the operating code. By means of the system bus 18 it is possible to externally process input data and output data in any desired endian mode. By way of example, data can be fed to a peripheral unit configured for data encryption. Before the encryption, the data are converted in accordance with the endian mode of the component instigating the encryption. The encrypted data that are returned are converted back once again depending on the respective endian mode.

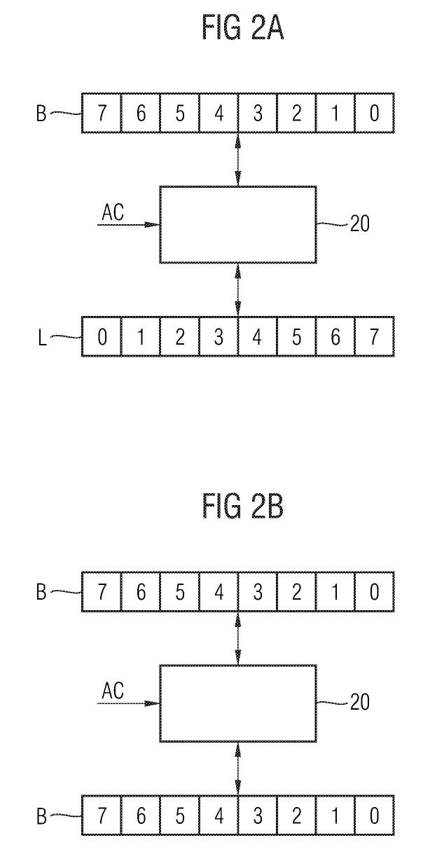

The conversion of data words in the conversion devices 20 will be explained in more detail below with reference to FIGS. 2a and 2b.

FIG. 2a shows data words each comprising 8 bytes, by way of example. A data word in the big endian mode is designated by B, while a data word in the little endian mode is designated by L. The bytes of the data words are numbered with rising significance from 0 to 7. In the configuration illustrated in FIG. 2a, an interchange function of the conversion device 20 is activated, such that the arrangement of the bytes in the data words is changed from the big endian mode to the little endian mode and vice versa.

In the configuration illustrated in FIG. 2b, the interchange function of the conversion device 20 is deactivated, that is to say that the arrangement of the bytes in the data words remains unchanged. FIG. 2b illustrates by way of example a data word in the big endian mode (designated by B), which is output in an unchanged manner by the conversion device as a data word in the big endian mode (likewise designated by B). It is to be understood, however, that in this configuration of the conversion device 20, a data word in the little endian mode which is input into the conversion device 20 is also output again as a data word in the little endian mode.

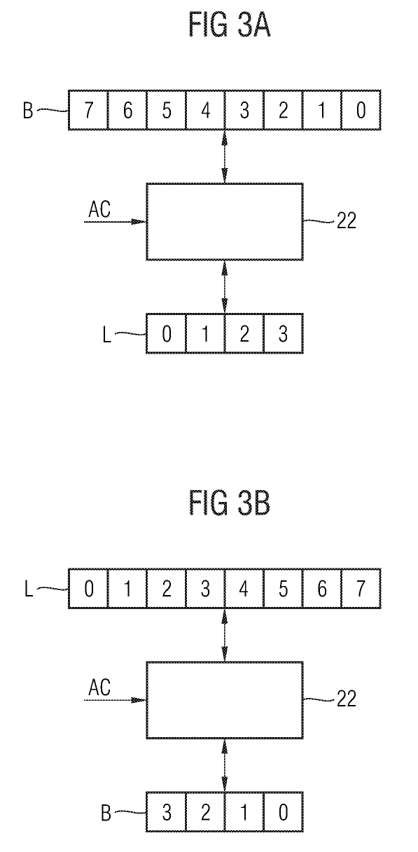

Next, the conversion of data words in the conversion devices 22 will be explained in more detail with reference to FIGS. 3a and 3b. In principle, the functioning corresponds to that of the conversion device 20 which has been explained with reference to FIGS. 2a and 2b. In the case of the conversion device 22, however, the data width of the data word communicated is additionally adapted. FIGS. 3a and 3b illustrate by way of example a data word comprising 8 bytes and a data word comprising 4 bytes, between which the conversion is effected. The data word comprising 8 bytes can also be referred to as a full data word, while the data word comprising 4 bytes can be referred to as a half data word.

FIG. 3a illustrates the conversion between a full data word in the big endian mode (designated by B) and a half data word in the little endian mode (designated by L). Some of the bytes of the full data word are omitted during the conversion. Which of the bytes are omitted can be decided by the conversion device depending on the data width information contained in the control signal AC in connection with the endian mode information likewise contained in the control signal AC. The first four bytes of the full data word are omitted in this case. Moreover, the rearrangement already explained is effected for the remaining bytes.

FIG. 3b illustrates the conversion between a full data word in the little endian mode (designated by L) and a half data word in the big endian mode (designated by B). Once again some of the bytes of the full data word are omitted depending on the control signal AC; the last four bytes in this case, however. The rearrangement already explained is effected for the remaining bytes.

Various modifications are possible in the case of the data processing device described above. Thus, by way of example, in accordance with one exemplary embodiment of the invention, it is possible to dispense with the conversion device 20 between the crossbar 14 and the ROM memory device 16 by virtue of corresponding conversion devices being respectively arranged between the processors 10a, 10b, 10c and the crossbar 14. Such an arrangement affords advantages to the effect that simplified conversion units can be used, for example, by virtue of a scrambling function being specifically adapted to the requirements of the respective processor.

Furthermore, an operating code comprising a code section for the little endian mode and a code section for the big endian mode can also be stored in the ROM memory device. By virtue of a further, typically short, code section being provided, which is endian-neutral and is configured for carrying out a checking of the endian mode of an access, an endian-mode-dependent branching to the corresponding code section can be provided within the operating code. In this case, it is possible to dispense with a conversion device between the crossbar 14 and the ROM memory device 16 as well.

Furthermore, in accordance with an embodiment of the invention, it is possible to formulate the operating code in endian-neutral fashion.

Moreover, in accordance with an embodiment of the invention, it is also possible to control the conversion devices 20, 22 in a manner other than by means of the control signal AC. By way of example, a register setting can be used for this purpose. Furthermore, it is possible to control the conversion devices in an addressing-dependent manner. In particular, two address ranges which are different from one another but which correspond physically to the same memory area could be provided in this case. The interchange function of the conversion device is activated in one of the address ranges. In this way, there is the possibility of dispensing with the use of a separate signal for communicating the access properties.

Finally, it is to be understood that the concepts described above are not restricted to the little endian mode and the big endian mode, but rather can be applied to any type of different byte orders in a data word. Thus, by way of example, the so-called middle endian mode could also be taken into account. Moreover, it is also possible to use more than two different endian modes simultaneously in the data processing device.

What is claimed is:

1. A data processing device, comprising:
a first component operable in a first endian mode; and
a second component coupled to the first component, the second component operable in a second endian mode that is different from the first endian mode.

2. The data processing device according to claim 1, wherein at least one of the first component and/or the second component are configured to generate a control signal comprising access property information.

3. The data processing device according to claim 2, wherein the access property information comprises endian mode information.

4. The data processing device according to claim 2, wherein the access property information comprises access type information.

5. The data processing device according to claim 2, wherein the access property information comprises data width information.

6. The data processing device according to claim 1, further comprising at least one conversion device for interchanging bytes in a data word transmitted between the first component and second component.

7. The data processing device according to claim 6, wherein the conversion device is coupled between the first component and the second component.

8. The data processing device according to claim 6, wherein the conversion device is coupled between the first and second component and a ROM memory device that stores an operating code of the first and second component.

9. The data processing device according to claim 6, wherein a single conversion device is provided both for the first component and for the second component, the conversion device being coupled between each component and a connecting structure for data communication between the components.

10. The data processing device according to claim 6, wherein the conversion device is controllable by a register setting.

11. The data processing device according to claim 6, wherein the conversion device is controllable depending on an address range of an access.

12. The data processing device according to claim 6, wherein the conversion device is controllable by a control signal comprising access property information.

13. The data processing device according to claim 1, further comprising a ROM memory device that stores an operating code of the first component and of the second component, the operating code being neutral with regard to the respective endian mode of the first component and of the second component.

14. The data processing device according to claim 1, further comprising a ROM memory device that stores an operating code of the first component and of the second component, the operating code comprising:
a first section, which is neutral with regard to the endian mode and is configured for checking an endian mode of an access;
a second section for the first endian mode;
a third section for the second endian mode; and
a branching to either the first section or the second section being provided in the operating code depending on checking carried out in the first section.

15. The data processing device according to claim 1, wherein the first component comprises a first processor, and wherein the second component comprises a second processor.

16. The data processing device according to claim 1, wherein the first component comprises a processor, and wherein the second component comprises a peripheral unit.

17. The data processing device according to claim 16, wherein the peripheral unit comprises a memory controller.

18. The data processing device according to claim 16, wherein the peripheral unit comprises a system bus.

19. The data processing device according to claim 16, wherein the peripheral unit comprises a DMA controller.

20. The data processing device according to claim 1, wherein the first and second components are implemented on a single semiconductor chip.

21. The data processing device according to claim 1, wherein the data processing device is configured to be used in a communication system.

22. The data processing device according to claim 1, wherein the data processing device is configured to be used in a computer system.

23. A method of data processing, the method comprising:
operating a first component of a data processing device in a first endian mode, and
operating a second component of the data processing device in a second endian mode, the first component and the second component being coupled to one another and the first endian mode being different from the second endian mode.
